(19) United States
(12) Patent Application Publication
(10) Pub. No.: US 2018/0290361 A1
(43) Pub. Date: Oct. 11, 2018

(54) Insert for Use in an Injection Molding Nozzle and Injection Molding Nozzle with Such an Insert

(71) Applicant: GÜNTHER Heisskanaltechnik GmbH, Frankenberg (DE)

(72) Inventors: Herbert GÜNTHER, Allendorf (DE); Siegrid SOMMER, Burgwald (DE); Torsten SCHNELL, Lichtenfels (DE)

(21) Appl. No.: 15/946,217

(22) Filed: Apr. 5, 2018

(30) Foreign Application Priority Data
Apr. 6, 2017 (DE) 10 2017 107 443.0

(51) Int. Cl. B29C 45/27

(52) U.S. Cl. CPC B29C 45/278; B29C 2045/2785

(57) ABSTRACT

The disclosure relates to an insert for use in an injection molding nozzle, with an insert body at least made from a high thermal conductivity material, in which at least one flow channel is formed with an inlet opening and an outlet opening, wherein the insert body comprises a neck section, for joining to the injection molding nozzle, an end section, for inserting into a mold cavity of a mold insert, and a flange with a stopping surface projecting radially with respect to the end section, wherein the stopping surface is formed on a surface of the radially projecting flange facing the outlet opening. According to the disclosure, the stopping surface and the end section have at least partly an outer coating made of a second material with a low thermal conductivity.

### CROSS-REFERENCE TO RELATED APPLICATIONS

This application claims priority to German Patent Application No. 10 2017 107 443.0 filed Apr. 6, 2017, entitled “Insert for Use in an Injection Molding Nozzle and Injection Molding Nozzle with Such an Insert,” which is incorporated by reference herein in its entirety.

### FIELD OF INVENTION

The invention relates to an insert for use in an injection molding nozzle as well as an injection molding nozzle for an injection mold with an insert.

### BACKGROUND

Injection molding nozzles, especially hot-channel nozzles, are used in injection molds in order to supply a flowable compound, such as a plastic material, at a given temperature under high pressure to a releasable mold insert. They usually have a material tube with a flow channel which is fluidically connected by an inlet opening to a distributor channel and emerges by an outlet opening in the gate opening of the mold insert (mold cavity).

All of the following remarks apply to both hot-channel systems and cold-channel systems.

So that the flowable material within the flow channel of the hot-channel nozzle does not cool down prematurely and harden, a heating device is provided, being placed or arranged on the outside of the material tube. Moreover, in order to ensure that the flowable compound is held at a uniform temperature up to the gate opening, a heat conducting sleeve made of a high thermal conductivity material is inserted at the end side in the material tube, being a continuation of the flow channel and forming at the end side the outlet opening for the injection molding nozzle.

In the case of an open nozzle, the heat conducting sleeve is usually designed as a nozzle mouthpiece and provided with a nozzle tip, terminating by its conical tip in or shortly before the plane of the gate opening. In the case of a needle valve nozzle, a tight seat for a valve needle is formed at the end side in the outlet opening of the heat conducting sleeve, which can move back and forth by means of a needle drive between an open and a closed position.

When processing abrasive materials or injection molding compounds which contain abrasive components, severe wear may occur on the heat conducting sleeve, especially at the outlet opening, so that the heat conducting sleeve or—depending on the design—the entire hot-channel nozzle needs to be replaced rather often. Especially in the case of needle valve nozzles, damage occurs to the tight seat for the valve needle, so that this can no longer be moved precisely from an open to a closed position during the periodic movement and the outlet opening is no longer tightly closed.

Furthermore, the individual components of an injection molding nozzle are generally exposed to an abrasive and adhesive wear. This wear is due to the fact that metallic components rub against other metallic components, without it being possible to use a lubricant, which might contaminate the injection molded products being produced.

In order to prevent wear, WO 2005/018906 A1 proposes an insert which is preferably made from a wear-resistant material. This is arranged at the mold insert-side end of a nozzle mouthpiece and is designed to be lengthwise movable either in itself or together with the nozzle mouthpiece. During the operation of the injection molding nozzle, the insert is clamped between the nozzle body and the mold insert. The insert serves for protection of the nozzle mouthpiece against heavy wear and optimizes the needle guidance of needle valve nozzles, since it functions as a centering body for both the valve needle and for the nozzle.

The drawback here is that the insert can only be made from a unitary material. Therefore, the insert either consists of a wear-resistant material or one uses high thermal conductivity material—as in another embodiment of WO 2005/018906 A1.

WO 2003/070446 A1 also proposes an insert which functions as a needle valve guide and as a wear protection means. Besides the embodiment already known from WO 2005/018906 A1 with a single-piece insert made either from thermally insulating or thermally conducting material, WO 2003/070446 A1 proposes a two-piece embodiment of the insert, in which the two individual parts of the insert may have different material properties. For example, an outer part (insulating part) made from a thermally insulating material and an inner part (guide part) of a thermally conductive material or a wear-resistant material is proposed. The thermally insulating material is used to reduce heat losses to the mold insert and the thermally conductive material is used to conduct heat from the tip to the melt in the guide opening.

The drawback to this embodiment is that the individual parts of the insert need to be made separately of the different materials and to be mounted individually in the injection molding nozzle. Both parts also need to be removed separately when a replacement becomes necessary. This increases the labor cost and the installation costs. Moreover, it may happen that the two single parts wear down at different rates, which is impractical for the handling and causes additional expense in the maintaining and inspecting of the injection mold. A further drawback is that the two-piece or multi-piece inserts have relatively large dimensions, which has unfavorable impact on the size of the hot-channel nozzle and thus on the possible hole gauges or cavity spacings.

### SUMMARY OF INVENTION

The goal of the invention is to overcome these and other drawbacks of the prior art and to create a compact insert for an injection molding nozzle, making use of several material properties in a single component part. In particular, a heat dissipation to the injection mold or the mold insert should be prevented. Furthermore, it should make possible a small design size of the injection molding nozzle. In particular, it should have an economical design with small dimensions and simple means and it should be easy to handle inside the mold. Moreover, the insert should be robust to the high alternating stress of cooldown and heating, and be resistant to wear. Furthermore, the insert should be interchangeable.

In an insert for use in an injection molding nozzle, with an insert body made from at least one high thermal conductivity material, in which at least one flow channel is formed with an inlet opening and an outlet opening, wherein the insert body comprises a neck section, for joining to the injection molding nozzle, an end section, for inserting into a mold cavity of a mold insert, and a flange with a stopping surface projecting radially with respect to the end section, wherein the stopping surface is formed on a surface of the radially projecting flange facing the outlet opening, wherein the stopping surface and the end section have at least partly an outer coating made of a second material with a low thermal conductivity.

It is thus possible, in only a single component, which is inserted for example into the lower, mold insert-side end of a material tube or a heat conducting sleeve of the injection molding nozzle, to combine several material properties and to use it for the injection molding nozzle and the flowable material being processed, without several different components being required and having to be mounted. The different materials can be chosen and combined according to the requirements, in particular the second material of the coating having a lower specific thermal conductivity than the first material. It is preferable to make the insert body of the insert from a high thermal conductivity material, in order to bring the heat generated by a heating of the injection molding nozzle as far as possible up to the gate opening. The coating, on the other hand, is made from a material with low thermal conductivity, in order to lessen the heat transmission to other components. The coating is preferably placed by force locking, integral bonding, and/or form fitting on the radially outer surface of the end section and the stopping surface of the insert body. This ensures a durable connection of the coating and the insert body to each other. The end section and the stopping surface made from a high thermal conductivity material and the coating made from a second material are preferably joined together across a contact surface.

In one preferred embodiment, it is proposed that the end section and the stopping surface have substantially entirely a coating of a second material. Thanks to the insulating properties of the coating, a heat transfer from the insert body to the surrounding components of the nozzle or the mold is prevented as much as possible, without changing the structural size of the insert body.

Preferably it is provided that both the high thermal conductivity material and the second material with a low thermal conductivity are wear-resistant and thus withstand mechanical stresses due to the flowable compound or surrounding components, for example in the form of a mold insert.

Thanks to the coating of the end section and the stopping surface with a second different material, the advantageous properties of the materials can be used precisely and in the smallest structural space, as best as possible. A cost and maintenance intensive installation of two individual parts is avoided. Likewise, no costly sealing elements or sealing surfaces are needed between the two materials, which might result in leakage at or in the injection molding nozzle or in the mold. Instead, the coating and the insert body are constantly joined together firmly and the insert forms a unitary component with minimal dimensions in its handling.

In one preferred embodiment, the second material with a low thermal conductivity is a ceramic material. Ceramic materials have a low thermal conductivity and furthermore they are wear-resistant and durable. An insert can therefore be provided which transfers little or no heat to the mold insert and furthermore has good resistance to mechanical stresses. Preferably, the second material with a low thermal conductivity comprises zirconium oxide.

Ceramics based on zirconium oxide have a low thermal conductivity, which is lower than the thermal conductivity of metallic materials, such as steel, which are preferably used as high thermal conductivity material of the insert body. In addition, zirconium oxide ceramics have expansion coefficients similar to metallic materials, especially steel. Thus, it is ensured that the outer coating also withstands rapid heating and cooling processes.

Alternatively, it is preferably proposed that second material with a low thermal conductivity comprises a plastic. Plastics have a low thermal conductivity and are furthermore easy to work, so that the manufacturing of an insert with a plastic coating is simple and economical. Preferably, the plastic contains polytetrafluorethylene. This plastic has a high melting temperature and long-term service temperature, so that the coating does not melt during use and the insert according to the invention has the longest possible service life.

Preferably, the high thermal conductivity material of the insert body and the second material with low thermal conductivity of the coating have substantially the same coefficient of thermal expansion. With almost the same coefficients of expansion, the insert can go through many heating and cooling cycles without the coating peeling off, for example.

In one preferred embodiment, the end section has an end face, in which the outlet opening is recessed, the outer coating of the second material with a low thermal conductivity ending before the end face. In this way, the end face of the insert consists exclusively of the high thermal conductivity material of the insert body, for example, which preferably comprises a metallic material. The end face of the insert is subjected to an increased mechanical loading, since it is continually placed in contact with a gate opening of a mold insert. Furthermore, the end face is also exposed to increased mechanical loads when mounting the insert in an injection molding nozzle. These increased mechanical loads might result in faster wearing of the less wear-resistant material and a peeling of the coating at an interface between two materials. The avoidance of such an interface ensures a long-lasting use of the insert.

Preferably, the outer coating of the end section and/or the stopping surface is arranged in a recess of the end section and/or the stopping surface, so that the end section and/or the stopping surface of the high thermal conductivity material and the outer coating of a second material form a flat outer surface at a boundary surface between the two materials. Thanks to this design, no projecting edge is created, which would be subjected to increased mechanical loads and would result in intensified wearing of the projecting material, especially the coating. The outer surface of the insert body is the radially outer surface of the insert body in this case. The outer surface of the flange, facing the outlet opening of the end section, corresponds to the stopping surface. This design of the insert results in a form fitting connection of the end section and the stopping surface of the flange with the outer coating.

In an alternative embodiment it is proposed that the coating fully covers the end face of the end section, the outlet opening being formed in the coating. Also with this embodiment, the end face exposed to an increased mechanical loading has no interface between two different materials, so that a peeling of the coating material is prevented. In this way, a long-lasting use of the insert is assured.

Furthermore, the coating of a material with a low thermal conductivity which also covers the end face of the insert body has the effect that the insert body is thermally insulated against a mold insert in the best possible way. The heat from a heating is not transferred to the mold insert, so that the insert of the injection molding nozzle has less heat loss and energy costs can be economized.

The coating of a second material with a low thermal conductivity can be applied with known coating methods to the end section and the stopping surface, especially in the region of the recess.

In one preferred embodiment, it is proposed that the flange has a thread on a radially outer surface. By means of this thread, the insert can be easily mounted in and removed from the injection molding nozzle. For example, if the insert is worn down or parts of the insert, such as the coating, become damaged, the insert can be simply replaced, without costly repair work being needed for the injection mold.

Preferably, the insert body is rotationally symmetrical to a longitudinal axis L. In this way, not only can the insert be produced easily, but also it can be installed quickly and without error in the injection molding nozzle.

In one preferred embodiment, the insert body of high thermal conductivity material with the end section, the neck section and the flange is designed as a single piece. A single-piece insert body can be produced easily and economically and furthermore it assures a durable functioning of the insert, especially the flow channel. The entire insert body comprises a single high thermal conductivity material.

In an alternative embodiment it is preferably provided that the insert body is two-piece or two-part. Preferably the insert body comprises a first part and a second part, wherein the first part is formed substantially by the neck section and the second part substantially by the end section. It is preferably provided that the first part is made from a high thermal conductivity material and extends from the neck section of the insert body as far as a boundary surface and the second part is made from a third material, which is different from the high thermal conductivity material of the first part, wherein the second part extends from the boundary surface as far as the end section of the insert body, and wherein the first part and the second part are joined firmly to each other in and/or along the boundary surface. The second part comprises at least partially the coating of a second material with a low thermal conductivity, in particular the second part comprises the coating of the second material in the region of the end section and the stopping surface.

In this way, it is possible to combine several material properties in only a single component, which is inserted for example into the lower, mold cavity-side end of a material tube or a heat conducting sleeve of the injection molding nozzle, and to use the flowable material being worked without requiring and having to install several different components. The different material properties can be chosen and combined in accordance with the requirements. If the first part of the insert is made from a high thermal conductivity material, the heat generated by a heating of the injection molding nozzle can be taken as far as possible up to the gate opening. The second part, on the other hand, made from a third material, can be produced for example from a wear-resistant material, in order to reduce the wear on the insert and thus increase the service life of the injection molding nozzle, especially when the second part of the insert forms the tight seat for a valve needle.

The first part and the second part of the insert can advantageously be made as separate parts, which are precisely and firmly joined together after their fabrication. Alternatively, it is also possible to produce at first a rough blank from a composite of the high thermal conductivity material and the third material and then fabricate the insert from this composite. Thanks to the connection of the two parts of the insert consisting of two different materials with an additional coating, the advantageous properties of the materials can be chosen precisely and in the smallest structural space, as best as possible. A cost and maintenance intensive installation of different single parts is avoided. Likewise, no costly sealing elements or sealing services are needed between the two parts, which might result in leakage at or in the injection molding nozzle or in the mold. Instead, the two parts are constantly joined together firmly and the insert forms a unitary component with minimal dimensions in its handling.

The connection extends by virtue of the boundary surface between the different materials used, so that although the properties of several materials are combined in a single component, at the same time a clear demarcation of materials is ensured on the different parts. A mixing of the two substances outside the boundary surface is prevented. This contributes to the optimal and precise utilization of the materials when using an insert in an injection molding nozzle.

Embodiments of the invention propose that the first part and the second part are joined together by integral bonding, form fitting, or frictional locking. With an integrally bonded connection, minimum dimensions can be achieved. But mechanical connections in the form of a form fitting or a frictional locking are also conceivable, for example by interlocking, screw fastening, press fitting or shrink fitting.

Due to the limited structural space, it is especially advantageous when the first and second part are joined together with integral bonding by means of welding, preferably by means of diffusion welding or laser welding.

Welding has proven to be the optimal method for connecting the first and the second part, because the first and the second part are usually formed from a metallic material and welding can produce a reliable and long-lasting stable connection between the parts. Diffusion welding in particular has benefits over other welding methods. The quality of the welded connections is exceptionally high. A pore-free, tight material composite is formed, meeting the highest mechanical, thermal and corrosion requirements. With diffusion welding, it is not necessary to use any added material, so that the seam has no foreign alloy components and thus possesses properties similar to those of the base materials, when properly designed. Furthermore, thanks to no molten fluid phase in the joining process, a highly precise and contour-true welding can be assured.

Besides welding, methods such as soldering or gluing may also be considered for the forming of integrally bonded connections.

Alternatively, the first part can be joined to the second part by means of a mechanical connection arrangement. For this purpose, a locking connection, a screw connection, a press fitting or a bayonet connection can be used, among others. The two parts can also be joined together by shrink fit. All of the aforementioned types of connection have the benefit that such a connection of the first part to the second part is durably firm and tight.

It is especially advantageous when the third material of the second part is a wear-resistant material. In this way, it is possible to reduce the wear on the insert—for example in the region of a needle guide—on account of the repeated sliding of the valve needle along the inner walls of the flow channel during active operation of the injection molding nozzle. At the same time, a high thermal conductivity design of the first part of the insert, which can be arranged for example on a heat conducting sleeve, ensures an optimal temperature distribution in the gate region.

It has proven to be advantageous when the thermally conductive material and the wear resistant material have a high thermal expansion. Thanks to the use of a material with high thermal expansion, the insert expands specifically during the heating of the injection mold, so that after reaching the operating temperature of the injection molding nozzle the insert is optimally clamped between material tube and/or heat conducting sleeve on the one hand and mold insert on the other hand and forms a durably tight arrangement.

In another advantageous design, the material of the first part and the material of the second part have an identical or nearly identical coefficient of expansion.

If the coefficients of expansion of the two parts of the insert are different, the difference between the coefficients of thermal expansion of the thermally conductive and the wear-resistant material takes into account the elastic capacities of the connection between the first and the second part, so that the two parts of the insert are always joined together durably and firmly.

In a special embodiment, the wear-resistant material is a tool steel. This is distinguished by good wear protection properties. Tool steel is more economical than other materials with comparable wear protection properties. In particular, a tool steel with low thermal conductivity may be advantageous, because in this case there is a thermal separation of the plastic melt from the mold insert of the injection mold, which prevents a premature cooldown of the plastic melt in the region of the second section. The additional coating of a material with a low thermal conductivity additionally supports this effect.

Alternatively, a ceramic which is distinguished by high wear resistance and low thermal conductivity could also be used as the wear-resistant material.

A further embodiment of the invention proposes that the boundary surface along which the first part is connected to the second part extends perpendicular to or obliquely to the longitudinal axis of the insert body. This produces, for example, a disk-shaped boundary surface with minimal expansion. Thanks to the perpendicular run of the boundary surface, an optimal connection can be produced between the first and the second part.

Alternatively to this, the boundary surface may also extend obliquely to the longitudinal axis of the insert body, for example, when a larger boundary surface is desired. The latter may be conically formed, for example. Thanks to a boundary surface oriented obliquely to the longitudinal axis, an integrally bonded connection can be strengthened in particular, since in this case a larger section is available as boundary surface.

In another special embodiment, the flange is preferably formed by the first part or the second part. In either variant, the flange is formed uniformly from one material and exhibits the properties of the respective material. In this way, the flange may either continue the heat conducting function of the neck section, for example, or enlarge the region of the end section which is protected by the wear-resistant material.

According to another embodiment, the flange is formed by the first part and the second part. In this way, the properties of the two materials can be combined optimally in the narrowest space. Since the flange functions primarily as a supporting flange, it comprises both regions having contact with the mold insert and regions which may lie against the material tube, the nozzle mouthpiece and/or the heat conducting sleeve, as required. Different requirements must be fulfilled in the two regions of the flange. While the temperature in the transitional region between flange and first section is constantly maintained high, at the same time the heat transfer from the material tube, the nozzle mouthpiece or the heat conducting sleeve to the mold insert is minimal. Furthermore, a more intense wearing must be assumed precisely at the contact surfaces, so that in these places a stronger wear protection is assured. Since the two parts of different materials form the flange, these opposite requirements can be fulfilled in a single component in the smallest space. This also holds in particular for the overall insert.

According to another advantageous embodiment, the insert forms a centering body for a valve needle of an injection molding nozzle. In this case, the insert forms in the first part and/or in the neck section a flow channel wall which tapers conically in the direction of the flange. Such a wall centers the valve needle during the closing movement, so that the free end of the valve needle can always run precisely in its tight seat. Preferably, the trend of the flow channel in the region of the first part and/or neck section is such that the valve needle is oriented already to the gate opening of the insert. Thus further prevents an excessive wear on the valve needle.

According to another important embodiment, the second part forms a tight seat for a valve needle of an injection molding nozzle. This can be accomplished, for example, by adapting the diameter of the flow channel in the region of the end section to the circumference of the valve needle of a needle valve nozzle. Corresponding embodiments have the advantage that the wear on the insert in the region of the end section, caused by repeated sliding of the valve needle along the surfaces of the flow channel, is significantly reduced.

According to another embodiment, the second part of the insert is configured to form, with its front end, a section of a wall of a mold cavity.

The neck section of the insert body is designed such that the insert can be optimally adapted by its neck section to the material tube, the nozzle mouthpiece or the heat conducting sleeve of an injection molding nozzle and thus can be easily inserted into these parts or placed on these parts—e.g., in the form of a sleeve. The end section, on the other hand, can be optimally adapted to another component, preferably to the mold insert or a mold nest plate—so that a problem-free installation in an injection mold is assured. The flange may function as a supporting flange, wherein the stopping surface of the flange rests against a mold insert and the top side of the flange rests against the material tube, the nozzle mouthpiece or the heat conducting sleeve. On the whole, such geometry produces a component whose dimensions can be optimally adapted, with minimal design size, to the geometry of the injection molding nozzle and the mold insert or the casting being produced. In the latter case, the insert acts to dictate the shape of the article being cast.

In one preferred embodiment, it is proposed that the end section with the outer coating is designed to form at least one sealing surface with a mold insert along an outer circumference. Thanks to the most precise possible adapting of the end section of the insert to the mold cavity of a mold insert, injection molded articles can be produced as precisely as possible. Furthermore, thanks to the coating according to the invention, a heat transfer from the insert to the mold insert is significantly reduced, so that a cooldown of the melt in the injection molding nozzle is prevented or at least minimized. Furthermore, this embodiment has a positive impact on the holding times during the molding process, which may be limited especially in the case of needle valve systems and thus involve risk.

Furthermore, the invention relates to an injection molding nozzle for an injection mold with an insert according to the invention. The injection molding nozzle may be either a hot-channel nozzle or a cold-channel nozzle. The insert may find use both in injection molding nozzles with open gate and nozzle tips and in injection molding nozzles with heat conducting sleeve and needle valve closure.

Injection molding nozzles with the insert according to the invention will profit from the coating of the insert body, i.e., only a single component needs to be handled during the installation. Thanks to the combination of several different materials, the advantageous properties of the materials can be utilized precisely and in the smallest design space, in the best possible way.

Thanks to the use of a high thermal conductivity material for the insert body or at least for the first part of the insert body and the providing of a coating of the end section and the stopping surface by a material with a low thermal conductivity, an optimal temperature distribution and thermal separation is achieved when feeding the melt inside the nozzle tip to the mold insert. Since a firm connection exists between the insert body and the coating, which can withstand even high alternating loads due to heating and cooling of the mold, not only does this avoid complicated and costly handling due to the installing of several individual parts, but also it provides a long-lasting and thus inexpensive injection molding nozzle.

When the injection molding nozzle is a needle valve nozzle, this has the further advantage that the insert additionally functions as a centering body, because the needle is guided precisely and with stable position inside the insert. This avoids damage to the valve needle, as well as wear effects on the insert.

The injection molding nozzle itself may comprise different components in different embodiments. All embodiments of the injection molding nozzle comprise a material tube, in which at least one flow channel is formed, which is fluidically connected to a mold cavity of the injection mold formed by at least one mold insert.

Depending on the embodiment, the injection molding nozzle furthermore has a heat conducting sleeve, which can be designed as a nozzle mouthpiece. The heat conducting sleeve is inserted into the material tube at the end, or mounted on the material tube, and it forms the outlet opening for the flow channel. The heat conducting sleeve is made from a high thermal conductivity material so that the melt can be fed at constant high temperature to the mold insert, without forming a so-called cold plug.

The insert according to the invention can be arranged at the mold insert-side end of the material tube, wherein the insert can be arranged at the mold insert side directly in or on the material tube or in or on a separate heat conducting sleeve. The insert may be inserted into or onto the material tube or the heat conducting sleeve. The neck section of the insert body is adapted accordingly for this. The insert is furthermore formed separate from the other components of the injection molding nozzle and constitutes a separate component of the injection molding nozzle. In this way, the materials of the insert can be chosen independently of the materials of the other components of the injection molding nozzle and be individually adapted to the particular requirements.

It has proven to be especially advantageous for the insert to be designed lengthwise movable in relation to the material tube, the nozzle mouthpiece or the heat conducting sleeve and the mold insert and during the operation of the injection molding nozzle—i.e., as soon as the mold has reached its operating temperature—it is clamped between the material tube and the mold insert, the nozzle mouthpiece and the mold insert or between the heat conducting sleeve and the mold insert. Thus, with this design, no length change due to different coefficient of thermal expansion on the hot-channel and/or cold-channel system needs to be taken into account. Thanks to the lengthwise movable seat, it is possible to install and remove the insert quickly and conveniently. No tools or other accessories are needed for this. Neither are any additional parts or accessories provided for the fastening of the insert in the injection molding nozzle, such as screw threads, threaded sleeves, or the like, either on the insert itself or in the injection molding nozzle, because the insert is reliably secured by clamping during the operation of the injection molding nozzle. Even so, the insert can always be quickly and economically replaced.

Furthermore, it is advantageous when the neck section is form fitted at least for a portion to the material tube, the nozzle mouthpiece or the heat conducting sleeve and the end section with the coating is form fitted at least for a portion to the mold insert. Thanks to the form fitting, a constantly tight connection is achieved, thereby preventing the melt from getting into interstices, while a lengthwise movement of the insert constantly remains possible, in order to balance out any heat-related changes in position of the injection molding nozzle. Thus, the insert with the other parts of the injection molding nozzle forms a plug-in system, from which the insert can be easily removed by pulling out without the use of tools, yet at the same time the injection molding nozzle is reliably secured by clamping during its operation.

### BRIEF DESCRIPTION OF THE DRAWINGS

Further features, details and benefits of the invention will emerge from the wording of the claims as well as the following description of sample embodiments with the aid of drawings. There are shown:

FIG. 1 illustrates a schematic longitudinal section through a first embodiment of an insert according to the disclosure,

FIG. 2 illustrates a schematic longitudinal section through another embodiment of an insert according to the disclosure,

FIG. 3 illustrates another schematic view of an embodiment of an insert according to the disclosure,

FIG. 4 illustrates a schematic longitudinal section through another embodiment of an insert according to the disclosure,

FIG. 5 illustrates a schematic longitudinal section through another embodiment of an insert according to the disclosure with a two-piece insert body and

FIG. 6 illustrates a schematic longitudinal section through another embodiment of an insert according to the disclosure with a two-piece insert body.

### DETAILED DESCRIPTION

When working with thermosetting plastics and elastomers, where the plastic hardens under temperature influence, cold-channel systems are used accordingly in place of hot-channel systems. Therefore, when hot-channel systems are described in the following, cold-channel systems are also always meant accordingly, depending on the application.

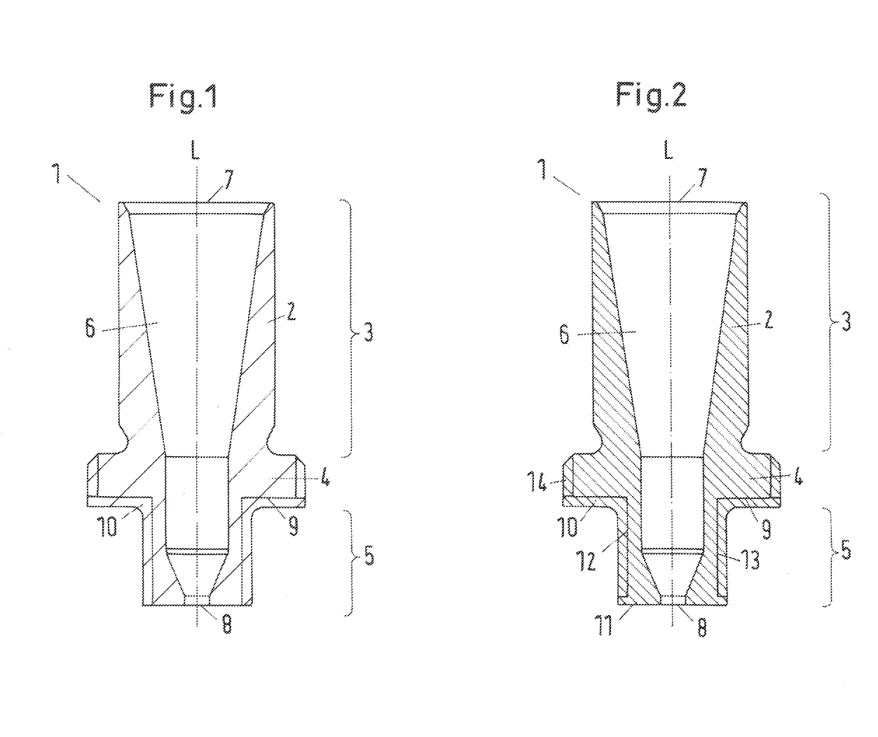

FIGS. 1 and 2 show a longitudinal section through an insert 1 according to the disclosure for an injection molding nozzle (not shown). The insert 1 is formed by a corresponding insert body 2 made from a high thermal conductivity material. Here, the insert body 2 comprises a neck section 3, a flange 4 and an end section 5. The insert body 2 can be joined by its neck section 3 to an injection molding nozzle, for example by inserting it into or placing it on the injection molding nozzle. The flange 4 projects radially with respect to the neck section 3 and the end section 5. The end section 5 can be inserted into a mold cavity of a mold insert (not shown) and is preferably adapted to the shape of the mold cavity. Furthermore, the insert body 2 has at least one flow channel 6 with an inlet opening 7 and an outlet opening 8. The end section 5 and a stopping surface 9 of the flange 4 have an outer coating 10 made from a second material with a low thermal conductivity, the stopping surface 9 being the surface of the flange 4 facing the outlet opening 8.

The insert body 2 is preferably rotationally symmetrical about a longitudinal axis L of the insert 1. The insert body 2 is preferably formed as a single piece with neck section 3, flange 4 and end section 5.

FIG. 2 shows a preferred embodiment, where the coating 10 made from a material with a low thermal conductivity ends before an end face 11 of the end section 5. The end face 11 of the end section 5 is the surface in which the outlet opening 8 is made and which is in connection with a gate opening of a mold insert. In this way, a boundary region between the two different materials of the insert body 2 and the coating 10 at the end face 11 is avoided, which would be subjected to an intensified mechanical loading.

It is furthermore preferred that the coating 10 is arranged in a recess 12 in the outer side of the end section 5. The stopping surface 9 of the flange 4 can also have such a recess 12, not being shown here. Through this recess 12, a form fitting connection can be achieved between the insert body 2 and the coating 10. The coating 10 made from a material with a low thermal conductivity and the insert body 2 made from a high thermal conductivity material have a flat outer surface, which stands up to mechanical stresses. In particular, the boundary region between the two different materials has a flat outer surface, so that no edge is exposed. Furthermore, the coating 10 and the end section 5 as well as the stopping surface 9 are joined together by a contact surface 13.

The flange 4 can preferably have a thread (not shown) on its radially outer surface 13, by which the insert 1 can be easily inserted into the injection molding nozzle and removed from it.

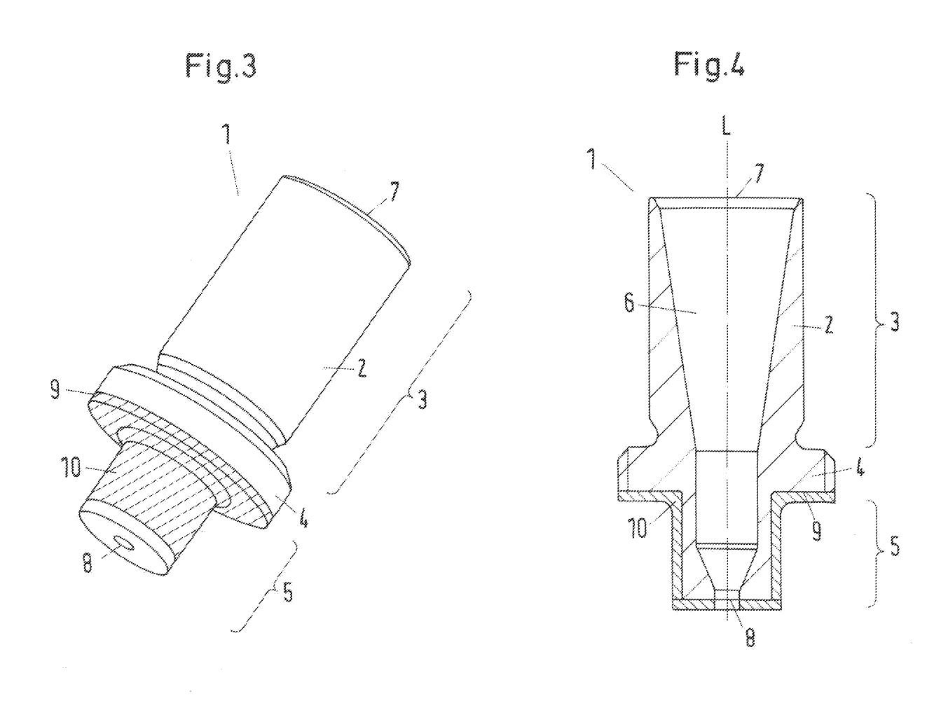

FIG. 3 shows a perspective view of the embodiment of an insert 1 according to the disclosure, as described in FIG. 2.

FIG. 4 shows an alternative embodiment of an insert 1 according to the invention, wherein the coating 10 besides the outer side of the end section 5 and the stopping surface 9 also covers the end face 11 of the end section 5. In this embodiment, the coating 10 has an outlet opening 8 on the end face 11 of the end section 5, from which the molten material emerges. Thanks to this design, no boundary surface is formed between two materials at the end face 11, which might result in a peeling off of the coating 10.

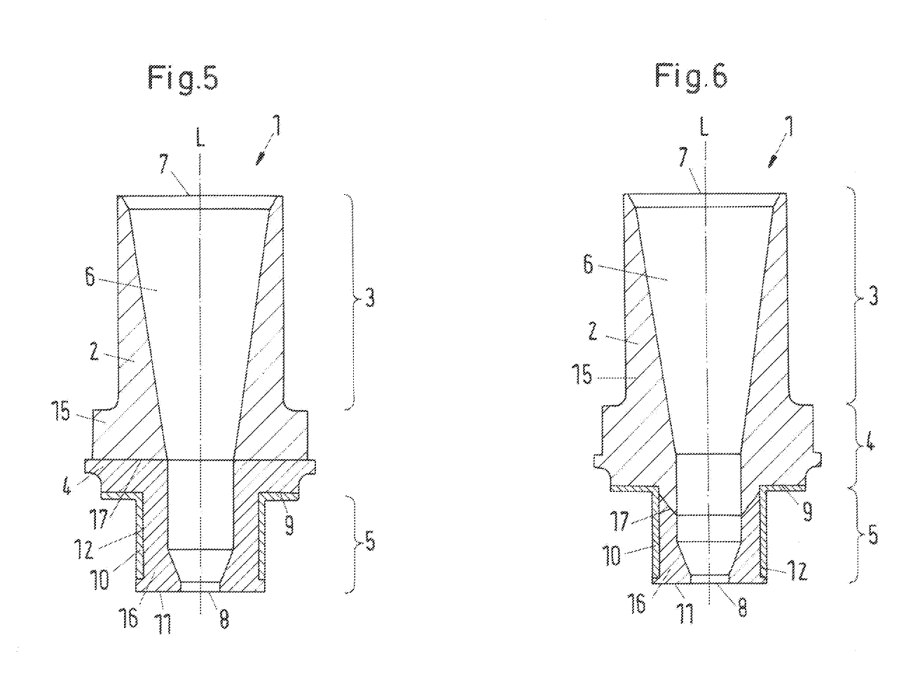

FIGS. 5 and 6 in each case show a longitudinal section through another preferred embodiment of an insert 1 according to the disclosure. In both FIGS. 5 and 6, the insert body 2 is two-piece. The insert body 2 comprises a first part 15 and a second part 16. The first part 15 is formed substantially by the neck section 3 and the second part 16 is formed substantially by the end section 5. It is preferable for the first part 15 to be made from a high thermal conductivity material and to extend across the neck section 3 of the insert body 2 as far as a boundary surface 17. The second part 16 is made from a third material and extends from the boundary surface 17 across the end section 5 of the insert body 2. The two parts 15, 16 are joined together in and/or along the boundary surface 17. The coating 10 in this embodiment is also provided on the stopping surface 9 of the flange 4 and at least in portions of the end section 5.

The coating 10 of a material with a low thermal conductivity ends in the embodiment shown before an end face 11 of the end section 5. It is furthermore preferable for the coating 10 to be arranged in a recess 12 in the outside of the end section 5.

FIG. 5 shows that the boundary surface 17 extends between the first part 15 and the second part 17 perpendicular to the longitudinal axis L of the insert body 2.

FIG. 6 shows an alternative configuration of the boundary surface 17. Here, the boundary surface 17 extends between the first part 15 and the second part 17 obliquely to the longitudinal axis L of the insert body 2.

The invention is not limited to one of the embodiments described above, but rather can be modified in many ways. Thus, one may configure the insert 1 with the neck section 3—as represented in FIGS. 1 to 6—such that the insert 1 can be inserted by its neck section 3 optimally into the material tube, the nozzle mouthpiece or the heat conducting sleeve of the injection molding nozzle. But one may also configure the neck section 3 so that this reaches around or across the outside of the material tube, the nozzle mouthpiece or the heat conducting sleeve. It is important that the stopping surface 9 and/or at least the end section 5 has at least partially an outer coating 10 made from a second material with a low thermal conductivity, so that a thermal separation occurs between the insert 1 and the mold.

One will therefore recognize that the invention proposes an insert 1 for use in an injection molding nozzle, with an insert body 2 made from a high thermal conductivity material, in which at least one flow channel 6 is formed with an inlet opening 7 and an outlet opening 8, the insert body 2 having a neck section 3 for connecting to the injection molding nozzle, an end section 5 for inserting into a mold cavity of a mold insert, and a flange 4 projecting radially with respect to the end section 5, having a stopping surface 9, wherein the stopping surface 9 is formed on a surface of the radially projecting flange 4 facing the outlet opening 8. According to the disclosure, the stopping surface 9 and the end section 5 have at least partially an outer coating 10 made from a second material with a low thermal conductivity.

All features and advantages emerging from the claims, the description, and the drawing, including design details, spatial arrangements, and method steps, may be significant to the invention both in themselves and in the most varied of combinations.

### LIST OF REFERENCE NUMBERS

1 Insert
2 Insert body
3 Neck section
4 Flange
5 End section
6 Flow channel
7 Inlet opening
8 Outlet opening
9 Stopping surface of flange 4
10 Coating
11 End face
12 Recess
13 Contact surface
14 Radially outer surface of flange 4
15 First part
16 Second part
17 Boundary surface
L Longitudinal axis of insert body 2

What is claimed is:

1. An insert for use in an injection molding nozzle, with an insert body made from at least one high thermal conductivity material, in which at least one flow channel is formed with an inlet opening and an outlet opening, wherein the insert body comprises a neck section, for joining to the injection molding nozzle, an end section, for inserting into a mold cavity of a mold insert, and a flange with a stopping surface projecting radially with respect to the end section, wherein the stopping surface is formed on a surface of the radially projecting flange facing the outlet opening, wherein the stopping surface and the end section have at least partly an outer coating made of a second material with a low thermal conductivity.

2. The insert as claimed in claim 1, wherein the second material with a low thermal conductivity comprises a ceramic material.

3. The insert as claimed in claim 1, wherein the second material with a low thermal conductivity comprises zirconium oxide.

4. The insert as claimed in claim 1, wherein the end section has an end face, in which the outlet opening is recessed, the outer coating of a second material with a low thermal conductivity ending before the end face.

5. The insert as claimed in claim 1, wherein the outer coating of the end section and/or the stopping surface is arranged in a recess of the end section and/or the stopping surface, so that the end section and/or the stopping surface made of the high thermal conductivity material and the outer coating made of a second material form a flat outer surface at a boundary surface between the two materials.

6. The insert as claimed in claim 1, wherein the flange has a thread on a radially outer surface.

7. The insert as claimed in claim 1, wherein the insert body is two-piece, the first part being formed substantially by the neck section and the second part substantially by the end section, and wherein the first part is made from a high thermal conductivity material and extends from the neck section of the insert body as far as a boundary surface and the second part is made from a third material, which is different from the high thermal conductivity material, wherein the second part extends from the boundary surface as far as the end section of the insert body, and wherein the first part and the second part are joined to each other in and/or along the boundary surface.

8. The insert as claimed in claim 7, wherein the boundary surface extends perpendicular to or obliquely to the longitudinal axis of the insert body.

9. The insert as claimed in claim 1, wherein the end section with the outer coating is designed to form at least one sealing surface with the mold insert along an outer circumference.

10. An injection molding nozzle for an injection mold with an insert as claimed in claim 1.

11. The injection molding nozzle as claimed in claim 10 with a material tube in which at least one flow channel is formed, which is fluidically connected to the mold cavity of the injection mold formed by the mold insert, wherein the insert can be arranged at the end of the material tube on the mold insert side.

12. The injection molding nozzle as claimed in claim 11, wherein the injection molding nozzle has a heat conducting sleeve, at whose end on the mold insert side the insert can be arranged.

13. The injection molding nozzle as claimed in claim 12, wherein the insert is designed to be lengthwise movable in relation to the material tube, a nozzle mouthpiece or the heat conducting sleeve and the mold insert and during the operation of the injection molding nozzle it is clamped between the material tube and the mold insert, the nozzle mouthpiece and the mold insert or between the heat conducting sleeve and the mold insert.

14. The injection molding nozzle as claimed in claim 13, wherein the neck section of the insert is form fitted at least for a portion to the material tube, the nozzle mouthpiece or the heat conducting sleeve and the end section with the outer coating is form fitted at least for a portion to the mold insert.

15. The injection molding nozzle as claimed in claim 13, wherein the neck section of the insert has a higher coefficient of thermal expansion than the material tube and/or the nozzle mouthpiece and/or the heat conducting sleeve.
